(19) United States
(12) Patent Application Publication
(10) Pub. No.: US 2008/0098089 A1
(43) Pub. Date: Apr. 24, 2008

(54) Method and apparatus for retransmission request reduction in a network

(75) Inventor: James V. Luciani, Acton, MA (US)

Correspondence Address: Ansel M. Schwartz;Attorney at Law, Suite 304, 201 N. Craig Street, Pittsburgh, PA, 15213, US

(73) Assignee: Ericsson, Inc.

(21) Appl. No.: 11/583,553

(22) Filed: Oct. 19, 2006

(51) Int. Cl. G06F 15/16

(52) U.S. Cl. 709/219

(57) ABSTRACT

A telecommunications system includes a connectionless network for distributing content which supports broadcast or multicast. The system includes a video server in communication with the network. The system includes a plurality of set-top boxes in communication with the network through which the set-top boxes receive packets from the server and have communication controlled by connectionless protocols which use a request for retransmission protocol for any given lost packet P which would otherwise flow between set top box and server. The system includes a proxy through which retransmission requests for a packet P from the set-top boxes are aggregated and a single request for retransmission of packet P is sent toward the server by the proxy on behalf of the plurality of set-top boxes and wherein the server sends a single retransmitted packet P back toward the proxy thus greatly reducing impact of retransmission protocol and packet retransmission on the network, upon reception of the packet P from the server for which the proxy acted on behalf of the plurality of set-top boxes, the proxy replicates and transmits the packet P once to and for each requesting set-top box. A method for communicating.

### FIELD OF THE INVENTION

The present invention is related to retransmission request reduction in a network that supports broadcast or multicast. More specifically, the present invention is related to retransmission request reduction in a network that supports broadcast or multicast having a proxy through which retransmission requests for a packet P from set-top boxes are aggregated and a single request for retransmission of packet P is sent toward a video server by the proxy on behalf of the plurality of set-top boxes and wherein the server sends a single retransmitted packet P back toward the proxy.

### BACKGROUND OF THE INVENTION

Resilient UDP is an algorithm used by set-top boxes in an IPTV network in order to request that packets which have been lost in the IPTV network be retransmitted from the video server to the set-top box. During high traffic volume IPTV events, this mechanism causes very large amounts of both control plane and dataplane activity when one or more set top boxes detect lost packets which would occur when an upstream traffic aggregation device loses the packet. Further, this increase in control plane and data plane activity occurs at the time when packet loss is already a problem due to likely existing network congestion. Resilient UDP is used by Microsoft's U-verse IPTV offering.

### BRIEF SUMMARY OF THE INVENTION

The present invention pertains to a telecommunications system. The system comprises a connectionless network for distributing content which supports broadcast or multicast. The system comprises a video server in communication with the network. The system comprises a plurality of set-top boxes in communication with the network through which the set-top boxes receive packets from the server and have communication controlled by connectionless protocols which use a request for retransmission protocol for any given lost packet P which would otherwise flow between set top box and server. The system comprises a proxy through which retransmission requests for a packet P from the set-top boxes are aggregated and a single request for retransmission of packet P is sent toward the server by the proxy on behalf of the plurality of set-top boxes and wherein the server sends a single retransmitted packet P back toward the proxy thus greatly reducing impact of retransmission protocol and packet retransmission on the network, upon reception of the packet P from the server for which the proxy acted on behalf of the plurality of set-top boxes, the proxy replicates and transmits the packet P once to and for each requesting set-top box.

The present invention pertains to a method for communicating. The method comprises the steps of receiving packets from a video server at a plurality of set-top boxes through a connectionless network for distributing content which supports broadcast or multicast and which have communication controlled by connectionless protocols which use a request for retransmission protocol for any given lost packet P which would otherwise flow between set top boxes and the server. There is the step of aggregating retransmission requests for a packet P from the set-top boxes at a proxy. There is the step of sending a single request for retransmission of packet P toward the server by the proxy on behalf of the plurality of set-top boxes. There is the step of sending by the server a single retransmitted packet P back toward the proxy thus greatly reducing impact of retransmission protocol and packet retransmission on the network. There is the step of receiving the packet P by the proxy from the server for which the proxy acted on behalf of the plurality of set-top boxes. There is the step of replicating and transmitting the packet P once to and for each requesting set-top box by the proxy.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a block diagram of the system of the present invention.

FIG. 2 is a block diagram of the system of the present invention.

### DETAILED DESCRIPTION OF THE INVENTION

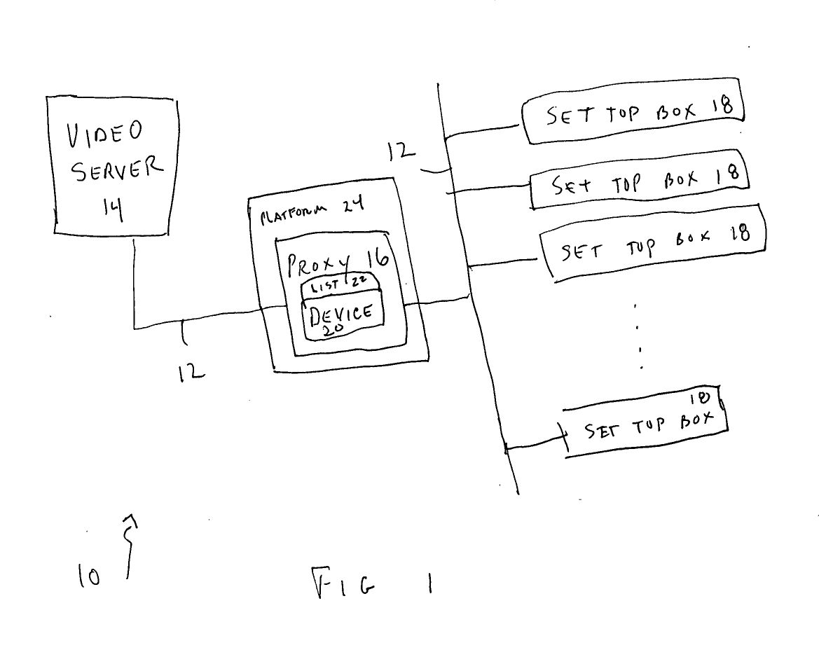

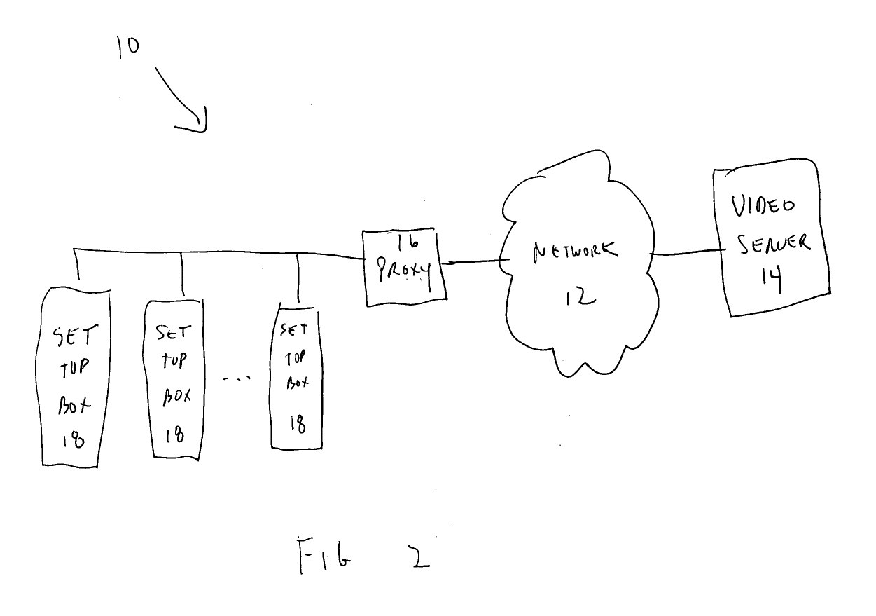

Referring now to the drawings wherein like reference numerals refer to similar or identical parts throughout the several views, and more specifically to FIGS. 1 and 2 thereof, there is shown a telecommunications system 10. The system 10 comprises a connectionless network 12 for distributing content which supports broadcast or multicast. The system 10 comprises a video server 14 in communication with the network 12. The system 10 comprises a plurality of set-top boxes 16 in communication with the network 12 through which the set-top boxes 16 receive packets from the server 14 and have communication controlled by connectionless protocols which use a request for retransmission protocol for any given lost packet P which would otherwise flow between set top box and server 14. The system 10 comprises a proxy 18 through which retransmission requests for a packet P from the set-top boxes 16 are aggregated and a single request for retransmission of packet P is sent toward the server 14 by the proxy 18 on behalf of the plurality of set-top boxes 16 and wherein the server 14 sends a single retransmitted packet P back toward the proxy 18 thus greatly reducing impact of retransmission protocol and packet retransmission on the network 12, upon reception of the packet P from the server 14 for which the proxy 18 acted on behalf of the plurality of set-top boxes 16, the proxy 18 replicates and transmits the packet P once to and for each requesting set-top box 16.

Preferably, the network 12 carries multimedia, data, or telephony services. The connectionless protocols preferably include transport protocols with some form of reliability. The proxy 18 can include a device 20 that examines packets as they transit the device 20 but which neither the set-top boxes 16 nor the server 14 are aware of the existence of the proxy 18. Alternatively, the proxy 18 can include a device 20 which is known to be in the network 12 and wherein the set-top boxes 16 are instructed to send retransmission requests to the proxy 18 directly rather than directly to the server 14. In the latter instance, the server 14 can be unaware of the existence of the proxy 18. Preferably, the multimedia, data, or telephony services are either IPTV or Voice over IP (VoIP). The transport protocols with some form of reliability preferably include Resilient UDP.

Preferably, the proxy 18 resides in a platform 24. The proxy 18 preferably has a list 22 of the set-top boxes 16 that have requested retransmission of packet P. Preferably, the proxy 18 has a state which is associated with the list 22 and the packet P and the proxy 18 maintains the state for a predetermined period of time. The proxy 18 is preferably disposed in the network 12 inline with control and dataplane traffic.

The present invention pertains to a method for communicating. The method comprises the steps of receiving packets from a video server 14 at a plurality of set-top boxes 16 through a connectionless network 12 for distributing content which supports broadcast or multicast and which have communication controlled by connectionless protocols which use a request for retransmission protocol for any given lost packet P which would otherwise flow between set top boxes and the server 14. There is the step of aggregating retransmission requests for a packet P from the set-top boxes 16 at a proxy 18. There is the step of sending a single request for retransmission of packet P toward the server 14 by the proxy 18 on behalf of the plurality of set-top boxes 16. There is the step of sending by the server 14 a single retransmitted packet P back toward the proxy 18 thus greatly reducing impact of retransmission protocol and packet retransmission on the network 12. There is the step of receiving the packet P by the proxy 18 from the server 14 for which the proxy 18 acted on behalf of the plurality of set-top boxes 16. There is the step of replicating and transmitting the packet P once to and for each requesting set-top box 16 by the proxy 18.

Preferably, there is the step of carrying multimedia, data, or telephony services by the network 12. The receiving the packets step preferably includes the step of receiving the packets from the video server 14 at the plurality of set-top boxes 16 through the connectionless network 12 for distributing content which supports broadcast or multicast and which have communication controlled by connectionless protocols that include transport protocols with some form of reliability.

The aggregating step can include the step of aggregating retransmission requests for the packet P from the set-top boxes 16 at the proxy 18 which includes a device 20 that examines packets as they transit the device 20 but which neither the set-top boxes 16 nor the server 14 are aware of the existence of the proxy 18. Alternatively, the aggregating step can include the step of aggregating retransmission requests for the packet P from the set-top boxes 16 at the proxy 18 which includes a device 20 which is known to be in the network 12 and wherein the set-top boxes 16 are instructed to send retransmission requests to the proxy 18 directly rather than directly to the server 14. In the latter instance, the server 14 is unaware of the existence of the proxy 18. The server 14 does not need to be aware of the proxy because the proxy will use its IP address as a source address for the retransmission (this is standard proxy behavior for any a proxy). Preferably, the multimedia, data, or telephony services are either IPTV or Voice over IP (VoIP). The transport protocols with some form of reliability preferably include Resilient UDP.

In the operation of the invention, a statefull proxy 18 function is realized as follows:
1) A set top box requests a packet retransmission
2) proxy 18 acts as a (possibly but not necessarily first) hop (may or may not be IP hop but in the case where the set top boxes are aware of the proxy, the proxy is likely to be an IP hop) for the retransmission request as it is sent to the appropriate video server 14.
3) proxy 18 maintains state for a period of time for each retransmission request
   a. the proxy 18 sends the retransmission request to the appropriate video server 14
   b. when another set top requests the same retransmission, the proxy 18 does not pass the retransmission request to the server 14 but maintains a log of which set top boxes requested the lost packet
   c. when the video server 14 sends the proxy 18 the requested lost packet, the proxy 18 transmits the lost frame to each of the set top boxes that requested it
   d. the proxy 18 holds this state (the resent packet and the list 22 of set top boxes requesting it) for a period of time after which the state is released

The value of the use of such a proxy 18 function is that the entire network 12 behind the proxy 18 device 20 all the way upstream to the video server 14 is spared the impact of both the control plane activity in the form of multiple retransmission requests sent from a plethora of set top boxes and that part of the network 12 is spared the dataplane activity which results from having to retransmit the same lost frame multiple times down the distribution network 12 toward the set top boxes for each set top which requested a retransmission.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A telecommunications system comprising:
a connectionless network for distributing content which supports broadcast or multicast;
a video server in communication with the network;
a plurality of set-top boxes in communication with the network through which the set-top boxes receive packets from the server and have communication controlled by connectionless protocols which use a request for retransmission protocol for any given lost packet P which would otherwise flow between set top box and server; and
a proxy through which retransmission requests for a packet P from the set-top boxes are aggregated and a single request for retransmission of packet P is sent toward the server by the proxy on behalf of the plurality of set-top boxes and wherein the server sends a single retransmitted packet P back toward the proxy thus greatly reducing impact of retransmission protocol and packet retransmission on the network, upon reception of the packet P from the server for which the proxy acted on behalf of the plurality of set-top boxes, the proxy replicates and transmits the packet P once to and for each requesting set-top box.

2. A system as described in claim 1 wherein the network carries multimedia, data, or telephony services.

3. A system as described in claim 2 wherein the connectionless protocols include transport protocols with some form of reliability.

4. A system as described in claim 3 wherein the proxy includes a device that examines packets as they transit the device but which neither the set-top boxes nor the server are aware of the existence of the proxy.

5. A system as described in claim 3 wherein the proxy includes a device which is known to be in the network and wherein the set-top boxes are instructed to send retransmission requests to the proxy directly rather than directly to the server.

6. A system as described in claim 5 wherein the server is unaware of the existence of the proxy.

7. A system as described in claim 6 wherein the multimedia, data, or telephony services may be IPTV or Voice over IP (VoIP) or other media over IP.

8. A system as described in claim 7 wherein an example of a transport protocol with some form of reliability might include Resilient UDP.

9. A method for communicating comprising the steps of:
receiving packets from a video server at a plurality of set-top boxes through a connectionless network for distributing content which supports broadcast or multicast and which have communication controlled by connectionless protocols which use a request for retransmission protocol for any given lost packet P which would otherwise flow between set top boxes and the server;
aggregating retransmission requests for a packet P from the set-top boxes at a proxy;
sending a single request for retransmission of packet P toward the server by the proxy on behalf of the plurality of set-top boxes;
sending by the server a single retransmitted packet P back toward the proxy thus greatly reducing impact of retransmission protocol and packet retransmission on the network;
receiving the packet P by the proxy from the server for which the proxy acted on behalf of the plurality of set-top boxes; and
replicating and transmitting the packet P once to and for each requesting set-top box by the proxy.

10. A method as described in claim 9 including the step of carrying multimedia, data, or telephony services by the network.

11. A method as described in claim 10 wherein the receiving the packets step includes the step of receiving the packets from the video server at the plurality of set-top boxes through the connectionless network for distributing content which supports broadcast or multicast and which have communication controlled by connectionless protocols that include transport protocols with some form of reliability.

12. A method as described in claim 11 wherein the aggregating step includes the step of aggregating retransmission requests for the packet P from the set-top boxes at the proxy which includes a device that examines packets as they transit the device but which neither the set-top boxes nor the server are aware of the existence of the proxy.

13. A system as described in claim 11 wherein the aggregating step includes the step of aggregating retransmission requests for the packet P from the set-top boxes at the proxy which includes a device which is known to be in the network and wherein the set-top boxes are instructed to send retransmission requests to the proxy directly rather than directly to the server.

14. A method as described in claim 13 wherein the server is unaware of the existence of the proxy.

15. A method as described in claim 14 wherein the multimedia, data, or telephony services might include IPTV or Voice over IP (VoIP) or other media over IP.

16. A method as described in claim 15 wherein an example of a transport protocol with some form of reliability might include Resilient UDP.
